(19) United States
(12) Patent Application Publication
(10) Pub. No.: US 2025/0266217 A1
(43) Pub. Date: Aug. 21, 2025

(54) BREAKING UNIT AND ELECTRICAL DEVICE

(71) Applicant: Schneider Electric Industries SAS, Rueil-Malmaison (FR)

(72) Inventors: Xu Han, Shanghai (CN); Yuanzhong Wang, Shanghai (CN); Wanruo Lou, Shanghai (CN)

(73) Assignee: Schneider Electric Industries SAS, Rueil-Malmaison (FR)

(21) Appl. No.: 19/026,964

(22) Filed: Jan. 17, 2025

(30) Foreign Application Priority Data
Feb. 21, 2024 (CN) 2024203208335

(51) Int. Cl. H01H 9/34; H01H 9/38

(52) U.S. Cl. CPC H01H 9/346; H01H 9/342; H01H 9/38

(57) ABSTRACT

The disclosure provides a breaking unit including a stationary contact with a contact surface facing a second direction perpendicular to the first direction; a moving contact arranged at the first side of the stationary contact in the second direction and configured to move relative to the stationary contact; a plurality of arc extinguishing grids arranged at the first side of the stationary contact and at intervals along the first direction; an arc extinguishing shield including a first section and a second section, wherein the first section and the second section are connected to partially surround the arc extinguishing grid, with gaps provided between the first section and the arc extinguishing grid, as well as between the second section and the arc extinguishing grid.

### TECHNICAL FIELD

The disclosure relates to the field of electricity, in particular to a breaking unit and an electrical device including the breaking unit.

### BACKGROUND

In the arc extinguishing chamber, when the arc is generated, high-temperature and high-pressure gas will be generated. The arc extinguishing chamber needs to have a gas port to exhaust gas to reduce the gas pressure in the arc extinguishing chamber. When the current is large, arc extinguishing grid is usually provided in the arc extinguishing chamber, and the arc current is reduced by cutting the arc to increase the arc voltage, so that the arc can be extinguished as soon as possible. Therefore, the air duct in the arc extinguishing chamber can be designed, so that the arc can completely enter the arc extinguishing chamber as much as possible by guiding the gas. However, in the design of the arc extinguishing chamber, it is necessary to avoid the arc from spraying directly to the outside of the electrical device, otherwise it will cause short circuit or personal injury.

The arc extinguishing chamber of traditional electrical device usually consists of two parts. One part is the arc extinguishing shield, and the other part is the face cover. The airflow flows from the arc extinguishing shield to the face cover first, and then flows out of the product. When arc occurs, especially when there is short-circuit current, high-pressure gas will be generated instantly in the arc extinguishing chamber. This will instantly impact the arc extinguishing shield and the face cover. If the connection between the face cover and the arc extinguishing shield is not reliable, the face cover will be lifted by the airflow. In order to strengthen the connection between the face cover and the arc extinguishing shield, reliable connection is needed, such as through screws. This structure will be more complicated, and the face cover has the function of blocking gas. Once the face cover falls, the whole product will fail.

Therefore, a high-strength and high-efficiency breaking unit structure is needed.

### SUMMARY

The purpose of the present disclosure is to at least solve the shortcomings existing in the prior art. The present disclosure proposes a breaking unit including a stationary contact with a section extending along a first direction, and a contact surface facing a second direction perpendicular to the first direction is provided on the section; a moving contact arranged at the first side of the stationary contact in the second direction and configured to move relative to the stationary contact to realize contact and separation with the contact surface of the stationary contact; a plurality of arc extinguishing grids arranged on the first side of the stationary contact at intervals along a first direction, wherein each of the plurality of arc extinguishing grids is parallel to each other and transverse to the first direction; an arc extinguishing shield including a first section arranged on one side of the arc extinguishing grid away from the stationary contact in the second direction and a second section arranged on one side of the arc extinguishing grid away from the moving contact in the first direction, wherein the first section and the second section are connected to partially surround the arc extinguishing grid, with gaps provided between the first section and the arc extinguishing grid, as well as between the second section and the arc extinguishing grid, and the arc extinguishing shield includes an outlet arranged on the second section.

According to the breaking unit disclosed by the invention, the moving path of the gas is lengthened, so that the gas can be fully cooled and discharged from the arc extinguishing chamber directly without causing short circuit or personal injury. Compared with the breaking unit including the face cover in the prior art, the face cover and the arc extinguishing shield do not need to be connected by screws, but only need to be connected by snap. The face cover is only decorative. When the face cover is missing, the product can still guarantee its function. It simplifies the connection between parts and increases the reliability of products. Moreover, the face cover does not need to be made of the same material as the arc extinguishing shield, or it does not need to have the same high insulation and high temperature resistance as the arc extinguishing shield. Because the face cover does not need to block gas, even when a large current (such as short-circuit current) impacts, the product is not easy to fail, and the reliability of the product is improved.

For example, according to some aspects of the present disclosure, the arc extinguishing shield further includes a third section arranged on the side of the moving contact that is away from the stationary contact in the second direction and on the side of the arc extinguishing grid that is close to the moving contact in the first direction, and a leading slope is arranged between the first section and the third section, which is inclined and/or bent relative to the second direction and the first direction.

For example, according to some aspects of the present disclosure, the third section, the leading slope, the first section and the second section are integrally formed.

For example, according to some aspects of the present disclosure, the plurality of arc extinguishing grids are arranged at intervals in alignment with each other along a first direction, and each of the plurality of arc extinguishing grids is perpendicular to the first direction.

For example, according to some aspects of the present disclosure, the breaking unit further includes an arc striking piece having a first arc striking section arranged between the arc extinguishing grid and the stationary contact, and a second arc striking section extending between the arc extinguishing grid and the second section of the arc extinguishing shield.

For example, according to some aspects of the present disclosure, the first end of the stationary contact, which is away from the moving contact in the first direction, extends out of the arc extinguishing shield to serve as a terminal.

For example, according to some aspects of the present disclosure, the breaking unit further includes a face cover which is arranged outside the arc extinguishing shield and does not block the outlet.

The disclosure also provides an electrical device, which includes any one of the above-mentioned breaking units.

For example, according to some aspects of the present disclosure, the electrical device further includes a junction box including a through hole aligned with the outlet.

For example, according to some aspects of the present disclosure, a gap is provided between the junction box and the arc extinguishing shield.

### BRIEF DESCRIPTION OF DRAWINGS

FIG. 1 shows a perspective schematic view of a part of an electrical device including a breaking unit according to an embodiment of the present disclosure;

FIG. 2 shows a schematic diagram of the flow of gas in a part of the electrical device of FIG. 1.

### REFERENCE LIST

1 stationary contact
11 first end
12 contact surface
2 moving contact
3 arc extinguishing grid
4 arc extinguishing shield
41 first section
42 second section
43 third section
44 leading slope
45 outlet
5 arc striking piece
51 first arc striking section
52 second arc striking section
6 face cover
7 junction box
D1 first direction
D2 second direction

### DETAILED DESCRIPTION

In order to make the purpose, scheme and advantages of the technical scheme of the present disclosure more clear, the technical scheme of the embodiment of the present disclosure will be described clearly and completely with the accompanying drawings of specific embodiments of the present disclosure. Unless otherwise specified, the terms used herein have the ordinary meaning in the art. Like reference numerals in the drawings represent like parts.

In the description of this disclosure, it should be noted that unless otherwise specified and limited, the terms “installation”, “link” and “connection” should be broadly understood, for example, they can be fixed connection, detachable connection or integrated connection; a mechanical connection or an electrical connection; they can be directly or indirectly connected through an intermediate medium, and can be connected inside two elements. For those skilled in the art, the specific meanings of the above terms in this disclosure can be understood in specific situations.

For convenience of explanation, in this disclosure, the orientation of the contact surface of the stationary contact for contacting with the moving contact is designated as the second direction D2, and the first direction D1 is designated to be perpendicular to the second direction D2.

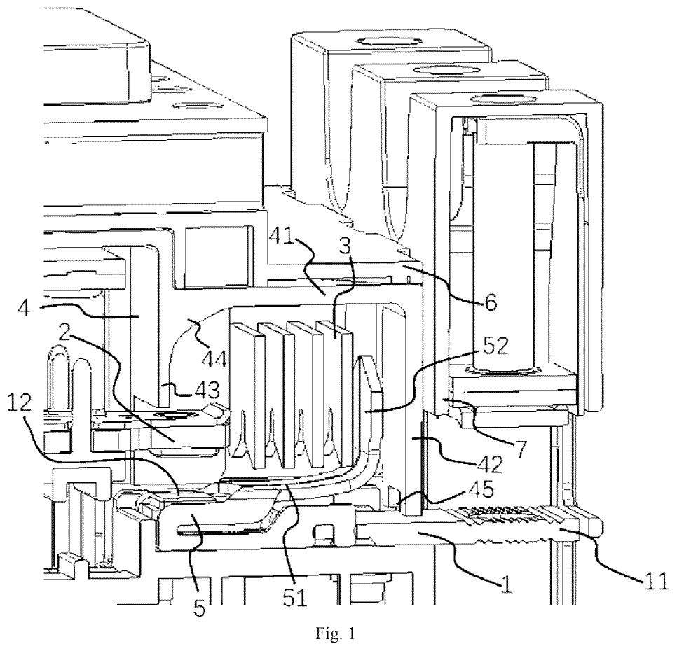

The breaking unit according to the present disclosure includes a stationary contact 1 and a moving contact 2, and the stationary contact 1 may be, for example, straight as shown in FIG. 1, or may have a curved shape. In addition, the stationary contact 1 has a section extending in the first direction D1, and a contact surface 12 is provided on the section. The stationary contact 1 may further include a first end portion 11 which is away from the moving contact in the first direction D1, and the first end portion 11 extends out of an arc extinguishing shield (described in detail later) to serve as a terminal.

The moving contact 2 may be arranged at a first side of the stationary contact 1 in the second direction D1. The moving contact 2 can be configured to move linearly in the second direction D2 relative to the stationary contact 1 to achieve contact and separation with the contact surface 12 of the stationary contact 1. In addition, the moving contact 2 can also be configured to pivot, and can also be realized to contact and separate from the contact surface 12 of the stationary contact 1.

The breaking unit according to the present disclosure may further include a plurality of arc extinguishing grids 3, which are arranged on the first side of the stationary contact 1 as described above at intervals along the first direction D1, that is, on the same side of the stationary contact 1 as the moving contact 2 in the second direction D2. The plurality of arc extinguishing grids 3 are parallel to each other and are all transverse to the first direction D1. In particular, a plurality of arc extinguishing grids 3 are arranged at intervals in alignment with each other along the first direction, and each arc extinguishing grid 3 is perpendicular to the first direction D1. This arrangement is compact, saves space, and is beneficial to miniaturization of the breaking unit.

The breaking unit according to the present disclosure may further include an arc extinguishing shield 4, which may include a first section 41, a second section 42, and a third section 43, wherein the first section 41 is arranged on one side of the plurality of arc extinguishing grids 3 that is away from the stationary contact 1 in the second direction D2, especially extending in the first direction D1; the second section 42 is arranged on one side of the plurality of arc extinguishing grids 3, which is away from the moving contact 2 in the first direction D1, especially extending in the second direction D2; the third section 43 is arranged on the side of the moving contact 2 that is away from the stationary contact 1 in the second direction D2 and on the side of the arc extinguishing grid 3 that is close to the moving contact 2 in the first direction D1, especially extending in the second direction D2.

In addition, the arc extinguishing shield 4 may further include a leading slope 44, which is arranged between the first section 41 and the third section 43. For example, the leading slope 44 may be inclined and/or curved relative to the first direction D1 and the second direction D2, such as including both inclined and curved sections as shown in FIG. 1. The position of the leading slope is just disposed to be opposite to the arc extinguishing grid 3 in the first direction D1 and to the contact surface 12 of the stationary contact 1 in the second direction D2. Therefore, when the breaking unit performs the breaking operation, that is, when the moving contact 2 is separated from the stationary contact 1, the generated gas moves in the gap between the arc extinguishing grid 3 and the third section 43 in the second direction D2 until it collides with the leading slope 44, and then changes to move in the direction towards the arc extinguishing grid 3 in the first direction D1. Therefore, it is beneficial to lead more arcs to the arc extinguishing grid, to extinguish the arc, and to increase the arc extinguishing ability of the breaking unit.

The first section 41, the second section 42, and the third section 43 may be provided with gaps with the arc extinguishing grid 3, respectively, to form gas passages for gas flow. The third section 43, the leading slope 44, the first section 41 and the second section 42 are connected in sequence to at least partially surround the arc extinguishing grids 3, so as to form an arc extinguishing chamber, preventing the gas from leaking and making the gas flow along the planned air passage. In particular, the third section 43, the leading slope 44, the first section 41 and the second section 42 may be integrally formed a component, that is, the arc extinguishing shield 4 is integrally formed, thereby further increasing the air tightness.

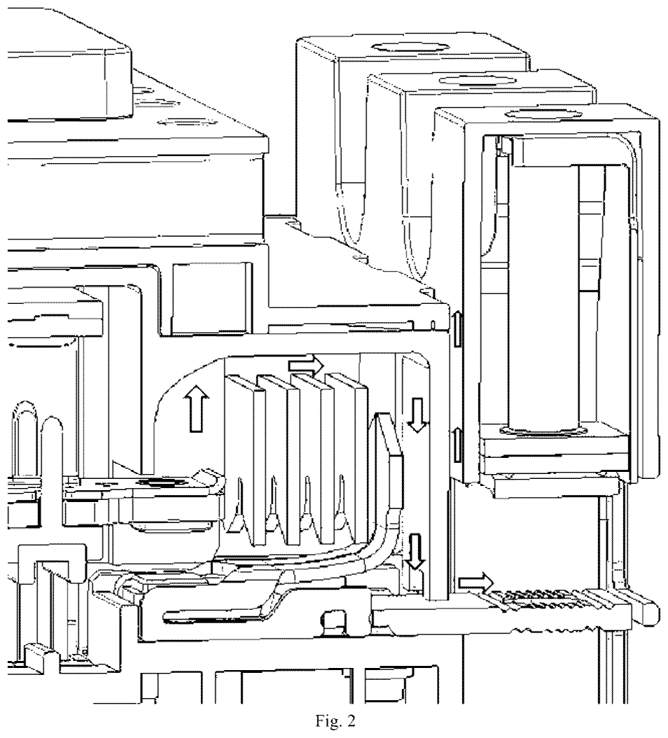

In addition, the arc extinguishing shield 4 also includes an outlet 45 arranged on the second section, especially, the outlet is close to the stationary contact 1, so that the gas generated during the breaking operation of the breaking unit flows out of the breaking unit from the outlet 45 through the gap along the third section 43, the leading slope 44, the first section 41 and the second section 42, and the gas flow direction is shown by the thicker arrow in FIG. 2. Therefore, the moving path of the gas is lengthened, so that the gas can be fully cooled and discharged from the arc extinguishing chamber directly without causing short circuit or personal injury.

In addition, the breaking unit may also include an arc striking piece 5, which may have a first arc striking section 51 arranged between the arc extinguishing grid 3 and the stationary contact 1, and a second arc striking section 52 extending between the arc extinguishing grid 3 and the second section 42 of the arc extinguishing shield 4. For example, as shown in FIG. 1, the arc striking piece 5 is generally J-shaped. Through the arrangement of the arc striking piece 5, it is further beneficial to lead the arc to the arc extinguishing grid and increase the arc extinguishing ability of the breaking unit.

The breaking unit according to the present disclosure further includes a face cover 6, which is arranged outside the arc extinguishing shield 4, for example, for protection and decoration. Moreover, the face cover 6 does not block the outlet 45, and does not participate in the arc extinguishing process, so that the gas generated during breaking can be directly discharged from the outlet 45 without being blocked after passing through the air passage arranged in the arc extinguishing chamber, and the face cover does not need to be specially fastened to the arc extinguishing shield 4, thus reducing the assembly difficulty. Moreover, since the face cover 6 does not need to act as a gas barrier, the performance requirements of the face cover 6 can be lower than those of the arc extinguishing shield, that is, there is no need for high insulation and high temperature resistance.

In addition, the breaking unit according to the present disclosure may further include two (not shown) moving contacts and stationary contacts, thereby including two arc extinguishing chambers, and the structures of the two arc extinguishing chambers are symmetrically arranged, such as central symmetry or mirror symmetry, depending on the arrangement of the moving contacts and the stationary contacts.

The present disclosure also provides an electrical device including one or more of the above-mentioned breaking units. The electrical device can be, for example, a contactor or a circuit breaker. The electrical device also includes a junction box 7, which includes a through hole aligned with the outlet 45, so as not to hinder the gas from flowing out of the arc extinguishing chamber.

Preferably, a gap is provided between the shell of the junction box 7 and the arc extinguishing shield 4 for the gas to flow out, so that even if the outlet 45 is blocked by the wiring, the gas can flow out of the electrical device through the gap, and the gas flow is shown by the thinner arrow in FIG. 2, so as to further increase the safety of the electrical device.

It should be understood that the above description is intended to be illustrative rather than limiting. For example, the above embodiments (and/or aspects thereof) may be used in combination with each other. In addition, many modifications may be made to adapt a particular situation or material to the teachings of this disclosure without departing from its scope. The functions or performances of various elements or modules described herein are only for illustration and are in no way restrictive, but only exemplary embodiments. Many other embodiments and modifications within the spirit and scope of the claims will be apparent to those skilled in the art after reading the above description. Therefore, the scope of the present disclosure should be determined with reference to the appended claims, along with the full scope of equivalents to which such claims are entitled.

In the appended claims, the terms “including” and “in which” are used as simple English equivalents of the corresponding terms “including” and “in which”. Furthermore, in the following claims, the terms “first”, “second” and “third” are only used as labels, and no numerical requirements are intended to be imposed on their objects.

1. A breaking unit, including
a stationary contact having a section extending along a first direction, the section is provided with a contact surface facing a second direction perpendicular to the first direction,
a moving contact arranged at the first side of the stationary contact in the second direction and configured to move relative to the stationary contact to realize contact and separation with the contact surface of the stationary contact,
a plurality of arc extinguishing grids arranged at the first side of the stationary contact and at intervals along the first direction, each of the plurality of arc extinguishing grids are parallel to each other and transverse to the first direction,
an arc extinguishing shield including a first section arranged on one side of the arc extinguishing grid away from the stationary contact in the second direction and a second section arranged on one side of the arc extinguishing grid away from the moving contact in the first direction, wherein the first section and the second section are connected to partially surround the arc extinguishing grid, with gaps provided between the first section and the arc extinguishing grid, as well as between the second section and the arc extinguishing grid, and the arc extinguishing shield includes an outlet arranged on the second section.

2. The breaking unit according to claim 1, wherein,
the arc extinguishing shield further includes a third section arranged on one side of the moving contact away from the stationary contact in the second direction and on one side of the arc extinguishing grid close to the moving contact in the first direction, and a leading slope is arranged between the first section and the third section and is inclined and/or bent relative to the second direction and the first direction.

3. The breaking unit according to claim 2, wherein,
the third section, the leading slope, the first section and the second section are integrally formed.

4. The breaking unit according to claim 1, wherein,
the plurality of arc extinguishing grids are arranged at intervals aligned with each other along the first direction, and each of the plurality of arc extinguishing grids is perpendicular to the first direction.

5. The breaking unit according to claim 4, wherein,
the breaking unit further includes an arc striking piece, and the arc striking piece is provided with a first arc striking section arranged between the arc extinguishing grid and the stationary contact and a second arc striking section extending between the arc extinguishing grid and the second section of the arc extinguishing shield.

6. The breaking unit according to claim 1, wherein,
the first end of the stationary contact, which is away from the moving contact in the first direction, extends out of the arc extinguishing shield to be used as a terminal.

7. The breaking unit according to claim 1, further includes a face cover, wherein the face cover is arranged outside the arc extinguishing shield and does not block the outlet.

8. An electrical device, including the breaking unit breaking unit including
a stationary contact having a section extending along a first direction, the section is provided with a contact surface facing a second direction perpendicular to the first direction,
a moving contact arranged at the first side of the stationary contact in the second direction and configured to move relative to the stationary contact to realize contact and separation with the contact surface of the stationary contact,
a plurality of arc extinguishing grids arranged at the first side of the stationary contact and at intervals along the first direction, each of the plurality of arc extinguishing grids are parallel to each other and transverse to the first direction,
an arc extinguishing shield including a first section arranged on one side of the arc extinguishing grid away from the stationary contact in the second direction and a second section arranged on one side of the arc extinguishing grid away from the moving contact in the first direction, wherein the first section and the second section are connected to partially surround the arc extinguishing grid, with gaps provided between the first section and the arc extinguishing grid, as well as between the second section and the arc extinguishing grid, and the arc extinguishing shield includes an outlet arranged on the second section.

9. The breaking unit according to claim 8, wherein,
the arc extinguishing shield further includes a third section arranged on one side of the moving contact away from the stationary contact in the second direction and on one side of the arc extinguishing grid close to the moving contact in the first direction, and a leading slope is arranged between the first section and the third section and is inclined and/or bent relative to the second direction and the first direction.

10. The breaking unit according to claim 9, wherein,
the third section, the leading slope, the first section and the second section are integrally formed.

11. The breaking unit according to claim 8, wherein,
the plurality of arc extinguishing grids are arranged at intervals aligned with each other along the first direction, and each of the plurality of arc extinguishing grids is perpendicular to the first direction.

12. The breaking unit according to claim 11, wherein,
the breaking unit further includes an arc striking piece, and the arc striking piece is provided with a first arc striking section arranged between the arc extinguishing grid and the stationary contact and a second arc striking section extending between the arc extinguishing grid and the second section of the arc extinguishing shield.

13. The breaking unit according to claim 8, wherein,
the first end of the stationary contact, which is away from the moving contact in the first direction, extends out of the arc extinguishing shield to be used as a terminal.

14. The breaking unit according to claim 8, further includes a face cover, wherein the face cover is arranged outside the arc extinguishing shield and does not block the outlet.

15. The electrical device according to claim 8, wherein,
the electrical device also includes a junction box including a through hole aligned with the outlet.

16. The electrical device according to claim 15, wherein,
a gap is arranged between the junction box and the arc extinguishing shield.
